(19) United States
(12) Patent Application Publication
(10) Pub. No.: US 2024/0266643 A1
(43) Pub. Date: Aug. 8, 2024

(54) RECHARGEABLE BATTERY

(71) Applicant: SAMSUNG SDI CO., LTD., Yongin-si (KR)

(72) Inventors: Jeawoan LEE, Yongin-si (KR); Kwangjo CHEONG, Yongin-si (KR); Daesung RO, Yongin-si (KR); Misun LEE, Yongin-si (KR)

(21) Appl. No.: 18/378,716

(22) Filed: Oct. 11, 2023

(30) Foreign Application Priority Data
Feb. 8, 2023 (KR) 10-2023-0016975

(51) Int. Cl. H01M 50/105; H01M 50/54

(52) U.S. Cl. CPC H01M 50/105; H01M 50/54

(57) ABSTRACT

An embodiment provides a rechargeable battery including: a stacked type electrode assembly in which a negative electrode plate and a positive electrode plate with electrode tabs are stacked on both sides of a separator; a pouch that accommodates the electrode assembly; a first film member that generates adhesive force through an electrolyte solution and is attached to the electrode assembly in a bent and connected state to both outer surfaces and side surfaces of an outer periphery of the electrode assembly; and a second film member that is spaced apart from the first film member to be attached to at least one of the both outer surfaces.

### CROSS-REFERENCE TO RELATED APPLICATION

This application claims priority to and the benefit of Korean Patent Application No. 10-2023-0016975 filed in the Korean Intellectual Property Office on Feb. 8, 2023, the entire contents of which are incorporated herein by reference.

### BACKGROUND

### 1. Field

The present disclosure relates to a rechargeable battery, and more particularly, to a rechargeable battery that may control a falling flow of an electrode assembly.

### 2. Description of the Related Art

A rechargeable battery is a battery that is repeatedly charged and discharged, unlike a primary battery. A small capacity rechargeable battery may be used in a small portable electronic device such as a mobile phone, a notebook computer, and a camcorder, while a large capacity rechargeable battery may be used as a power source for driving a motor of a large device such as a hybrid vehicle or an electric vehicle.

The rechargeable battery may include, for example, an electrode assembly for charging and discharging, a pouch accommodating the electrode assembly, and an electrode tab that electrically connects the electrode assembly and draws electricity out of the pouch. The electrode assembly may be, as an example, a winding type in which a negative electrode plate and a positive electrode plate are wound with a separator interposed therebetween, or a stacking type in which a negative electrode plate and a positive electrode plate are stacked with a separator interposed therebetween.

Pouch cells may mainly be used in mobile electronic devices. Therefore, due to negligence in handling or other factors, the pouch cell could frequently fall down. An internal short circuit caused by a pouch cell falling could stop the operation of the electronic device or could lead to ignition of the electronic device, causing significant damage to human life or property.

There is a method of applying tape to address the falling problem. When the falling impact strength increases, that is, when the weight of the cell increases or the falling height and frequency increase, a pull-back phenomenon may occur in which the separator comes out backward due to the falling of the electrode assembly. Due to the pull-back phenomenon, the electrode substrate or the electrode composite may be exposed to the outside, which could cause an internal short circuit.

### SUMMARY

Embodiments are directed to a stacked type electrode assembly in which a negative electrode plate and a positive electrode plate with electrode tabs are stacked on both sides of a separator; a pouch that accommodates the electrode assembly; a first film member that generates adhesive force through an electrolyte solution and is attached to the electrode assembly in a bent and connected state to both outer surfaces and side surfaces of an outer periphery of the electrode assembly; and a second film member that is spaced apart from the first film member and attached to at least one of the both outer surfaces.

The present disclosure is to provide a rechargeable battery that may control the falling flow of an electrode assembly. The present disclosure is to provide a rechargeable battery that may prevent the pull-back phenomenon of the electrode assembly even when the falling impact strength is high.

The present disclosure is to provide a rechargeable battery that may improve flatness between a pouch and an oriented polystyrene (OPS) film while controlling a pull-back phenomenon of a separator by applying the OPS film. The present disclosure is to provide a rechargeable battery that may prevent a problem caused by falling flow by increasing a contact area between a pouch and an OPS film.

The first film member and the second film member may be made of an oriented polystyrene (OPS) film.

The negative electrode plate and the positive plate may have a plane area in first and second directions crossing each other and are stacked in a third direction crossing the plane area; the electrode tab may be drawn out of the pouch along the first direction; and the first film member may be provided on both sides of the first direction and both sides of the second direction, respectively of the electrode assembly.

The first film member may include a pair of first-direction films that are stretched and adhered on both sides of the second direction in the first direction, and a second-direction film that is stretched and attached in the second direction between the pair of first direction films on a side opposite to a drawing direction of the electrode tab.

The second-direction film may be divided and attached along the second direction between the pair of first-direction films.

The second-direction film may further include a film between tabs attached between the electrode tabs.

The second film member may be attached to at least one of the both outer surfaces, between the pair of first-direction films and on one side of the second-direction film.

The first film member and the second film member may closely adhere to an inner surface of the pouch.

The first film member may have a first thickness, and the second film member may have a second thickness that is twice the first thickness and may be attached to one of the both outer surfaces of the electrode assembly.

The first thickness may be 24 μm to 34 μm, and the second thickness may be 51 μm to 61 μm.

The first film member may have a first thickness, and the second film member may have the first thickness and may be attached to the both outer surfaces of the electrode assembly.

The first film member may have a first area A1, the second film member may have a second area A2, and the first area A1 may be 60 to 80% of the second area A2 [A1−(0.6−0.8)*A2].

The first film member may include a pair of second-direction films that are stretched and adhered on both sides of the first direction in the second direction, and a first-direction film that is stretched and attached in the first direction between the pair of second direction films.

Among the pair of second-direction films, the second direction film on the electrode tab side may be provided with a pair of through-holes through which the electrode tabs are respectively drawn out.

The pair of second-direction film may entirely be attached to the both outer surfaces and the side surfaces in the second direction.

The first film member may have a first area A21, the second film member may have a second area A22, and the first area A21 may be 90 to 110% of the second area A22 [A21=(0.9−1.1)*A22].

The rechargeable battery may further include a binder layer applied to the both surfaces of the electrode assembly, wherein the first film member and the second film member may be attached on the binder layer.

It is possible to control the falling flow and pull-back in the electrode assembly by attaching both outer surfaces and side surfaces of the stack-type electrode assembly with the first film member, it is possible to improve the flatness of the first film member and the electrode assembly because the second film member is attached to both outer surfaces or one outer surface of the electrode assembly, and it is possible to increase a contact area between the first and second film members and the pouch.

### BRIEF DESCRIPTION OF THE DRAWINGS

Features will become apparent to those of skill in the art by describing in detail exemplary embodiments with reference to the attached drawings in which:

FIG. 1 illustrates a perspective view of a rechargeable battery according to a first embodiment.

FIG. 2 illustrates an exploded perspective view of FIG. 1.

FIG. 3 illustrates a top plan view of an electrode assembly applied to FIG. 2.

FIG. 4 illustrates a cross-sectional view taken along line IV-IV of FIG. 3.

FIG. 5 illustrates a top plan view of an electrode assembly of a rechargeable battery according to a second embodiment of the present disclosure.

FIG. 6 illustrates a side view viewed from positive and negative tab sides of FIG. 5.

FIG. 7 illustrates a top plan view of an electrode assembly of a rechargeable battery according to a third embodiment of the present disclosure.

FIG. 8 illustrates a cross-sectional view taken along line VIII-VIII of FIG. 7.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

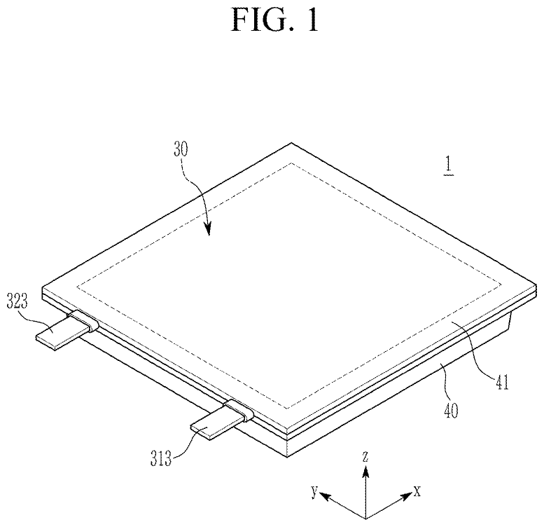

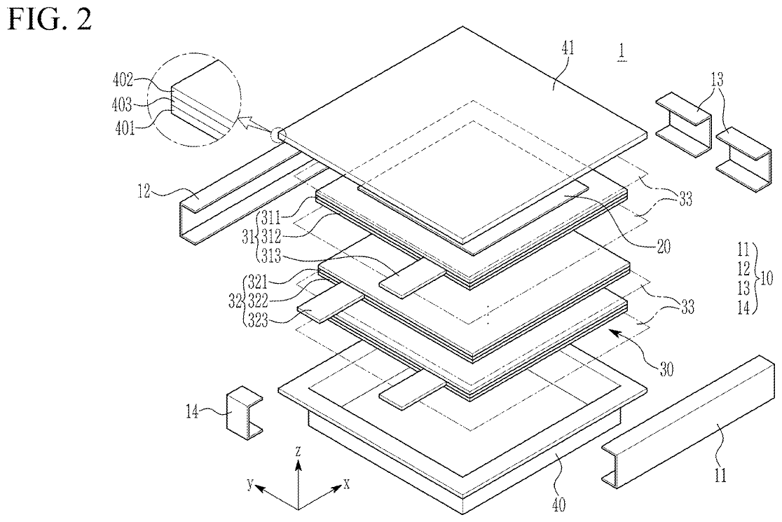

FIG. 1 illustrates a perspective view of a rechargeable battery according to a first embodiment of the present invention, and FIG. 2 illustrates an exploded perspective view of FIG. 1.

Referring to FIG. 1 and FIG. 2, a rechargeable battery 1 of the first embodiment may include an electrode assembly 30, a pouch 40 accommodating the electrode assembly 30, and a first film member 10 and a second film member 20 attached to the electrode assembly 30.

The electrode assembly 30 may include a separator 33, and a first electrode plate 31 and second electrode plate 32 formed as single sheets on both surfaces of the separator 33. That is, the electrode assembly 30 may include a plurality of the first electrode plates 31 and the second electrode plates 32 alternately disposed between a plurality of separators 33.

As an example, the first electrode plate 31 may be a positive electrode plate and may include a positive electrode active material layer 312 on both surfaces of an electrode current collecting plate 311. The first electrode plate 31 may include an electrode tab 313 formed of an uncoated region of the electrode current collecting plate 311 that protrudes to one side. The electrode tab 313 may be directly drawn out of the pouch 40, or may be connected to a lead tab (not shown) and drawn out of the pouch 40.

The second electrode plate 32 is a negative electrode plate and includes negative electrode active material layers 322 on both surfaces of an electrode current collecting plate 321. The second electrode plate 32 includes an electrode tab 323 of an uncoated region protruding to one side. The electrode tab 323 is directly drawn out of the pouch 40, or is connected to a lead tab (not shown) and drawn out of the pouch 40.

The positive electrode plate 31 and the negative electrode plate 32 may have a planar area in a first direction (x-axis direction) and a second direction (y-axis direction) crossing each other, and that are stacked in a third direction (z-axis direction) crossing the planar area. The electrode tabs 313 and 323, that is, the positive electrode tab 313 and the negative electrode tab 323 may be spaced apart from each other along the second direction, and may be drawn out of the pouch 40 along the first direction.

For example, the pouch 40 and a cover 41 may include a polymer sheet 401 that forms an inner surface and acts as electrical insulation and thermal bonding, a nylon sheet 402 that forms an outer surface and acts as protection, and an aluminum sheet 403 that provides mechanical strength.

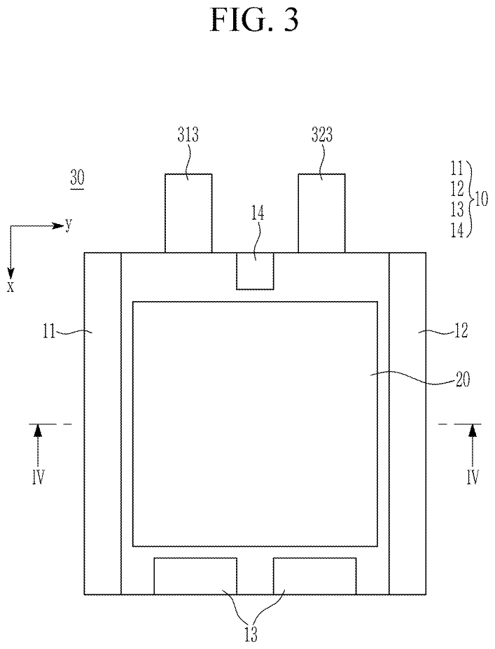

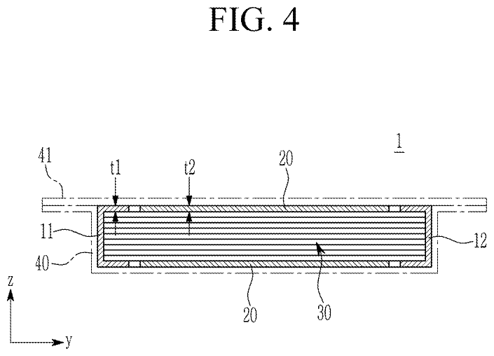

FIG. 3 illustrates a top plan view of an electrode assembly applied to FIG. 2, and FIG. 4 illustrates a cross-sectional view taken along line IV-IV of FIG. 3.

Referring to FIG. 2 to FIG. 4, the first film member 10 generates adhesive force through an electrolyte solution and is attached to the electrode assembly 30 in a bent and connected state to both outer surfaces and side surfaces of the outer periphery of the electrode assembly 30.

The first film member 10 may surround both outer surfaces and side surfaces of the outer periphery of the electrode assembly 30, thereby controlling the falling flow of the electrode assembly 30. The first film member 10 may prevent a pull-back phenomenon of the electrode assembly 30 in which the separator 33 comes out backward even when the falling impact is great.

The second film member 20 may generate adhesive force through the electrolyte solution. The second film member 20 may be spaced apart from the first film member 10 and attached to one or both of the outer surfaces of the electrode assembly 30. The second film member 20 may overcome a decrease in flatness of the first film member 10 and the electrode assembly 30 due to the use of the first film member 10, such that the contact area between the first and second film members 10 and 20 and the inner surface of the pouch 40 is increased. As described above, since the first and second film members 10 and 20 attached to the electrode assembly 30 come into contact with the inner surface of the pouch 40 over a large area, a falling flow of the electrode assembly 30 may be further controlled.

For example, the first film member 10 and the second film member 20 may be made of an oriented polystyrene (OPS) film. The first film member 10 and the second film member 20 may generate adhesive force through the electrolyte solution accommodated in the pouch 40.

The first film member 10 may be provided on both sides of the first direction (x-axis direction) and both sides of the second direction (y-axis direction), respectively of the electrode assembly 30. As an example, the first film member 10 may include a pair of first-direction films 11 and 12 stretched and attached (for example, adhered) on both sides of the second direction (y-axis direction) in the first direction (x-axis direction). A second-direction film 13 may be stretched and attached in the second direction (y-axis direction) between the pair of first-direction films 11 and 12 on the opposite side of the drawing direction of the positive electrode tab 313 and the negative electrode tab 323.

The second-direction film 13 may be divided and attached along the second direction (y-axis direction) between the pair of first-direction films 11 and 12. The second-direction film 13 may further include a film 14 between tabs attached between the positive electrode tab 313 and the negative electrode tab 323.

Among the first film member 10, the first-direction films 11 and 12 may control and prevent the falling flow in both sides of the second direction (y-axis direction) of the electrode assembly 30. The second-direction film 13 and the film 14 between the tabs may control and prevent the falling flow in both sides of the first direction (x-axis direction) of the electrode assembly 30. Since the first film member 10 has adherence by the electrolyte solution, the first film member may control and prevent the falling flow of the electrode assembly 30.

The second film member 20 may be attached to one outer surface or both outer surfaces of the electrode assembly 30 between the pair of first-direction films 11 and 12 and at one side of the second-direction film 13. The first film member 10 and the second film member 20 may be closely adhered to the inner surface of the pouch 40.

Accordingly, the second film member 20 may control non-uniform flatness between the electrode assembly 30 and the pouch 40 by the first film member 10. The second film member 20 may improve flatness between the first film member 10 and the surface of the electrode assembly 30, such the contact area between the first and second film members 10 and 20 and the pouch 40 may be improved.

The first film member 10 may have a first thickness t1, and the second film member 20 may have a second thickness t2. The first film member 10 and the second film member 20 may be attached to both outer surfaces of the electrode assembly 30 (see FIG. 4). In this case, the first and second thicknesses t1 and t2 may be the same. For example, the first and second thicknesses t1 and t2 may be 24 μm to 34 μm.

Although not separately shown, the first film member 10 may have a first thickness, and the second film member 20 may have a second thickness that is twice the first thickness. The first film member 10 and the second film member 20 may be attached only to one of the two surfaces of the electrode assembly. In this case, the first thickness t1 may be 24 μm to 34 μm, and the second thickness t2 may be 51 μm to 61 μm.

Referring back to FIG. 3, the first film member 10 (11, 12, 13, 14) may have a first area A1, and the second film member 20 may have a second area A2. The first area A1 may be 60 to 80% of the second area A2 [A1=(0.6−0.8)*A2].

If the first area A1 were to be less than 60% of the second area A2, due to the lack of the first area A1 of the first film member 10, the plane and the side surface of the electrode assembly 30 might not be sufficiently fixed, so that the falling flow might not be sufficiently controlled. If the first area A1 were to exceed 80% of the second area A2, due to the excess of the first area A1 of the first film member 10, it might be difficult to attach the plane and the side surface of the electrode assembly 30.

A change may occur in the entire thickness of the electrode assembly 30 before and after the pressurization formation of the rechargeable battery 1. A step change may occur according to the thickness change of the first film member 10 before and after the pressurization formation. The thickness change of the second film member 20 before and after pressurization formation may absorb the step change due to the thickness change of the first film member 10 before and after pressurization formation.

In the pressurization formation, charging and discharging proceeds while pressure is applied to a plate against both sides of the rechargeable battery 1 such that the electrode assembly 30 may be uniformly charged and discharged under a flat condition.

That is, during the pressurization formation, the first electrode plate 31 (positive electrode plate) and the second electrode plate 32 (negative electrode plate) of the rechargeable battery 1 may expand and contract. According to this charging and discharging, the electrode assembly 30 may expand up to 15%.

In this case, the first film member 10 and the second film member 20 may be expanded and controlled while receiving a pressing force. Therefore, the first film member 10 and the second film member 20 have an overall thickness of the same level without a thickness step.

For example, when the thickness of the electrode assembly 30 is 5.0 mm, the thickness may increase to 5.750 mm during pressurization formation charging. That is, the thickness of the electrode assembly 30 may become thicker by 750 μm.

In this case, thickness steps between the first and second film members 10 and 20 may be offset by each other, and the first and second film members 10 and 20 may have a same level of overall thickness. Accordingly, the flatness of the surface of the rechargeable battery 1 may be increased. When the surface of the rechargeable battery 1 is subjected to a uniform pressure, adhesion between the first electrode plate 31, the separator 33, and the second electrode plate 32 may be increased.

Hereinafter, various embodiments of the present disclosure will be described. Descriptions of configurations that are the same as the first embodiment or the configuration described above will be omitted, and descriptions of other configurations will be provided.

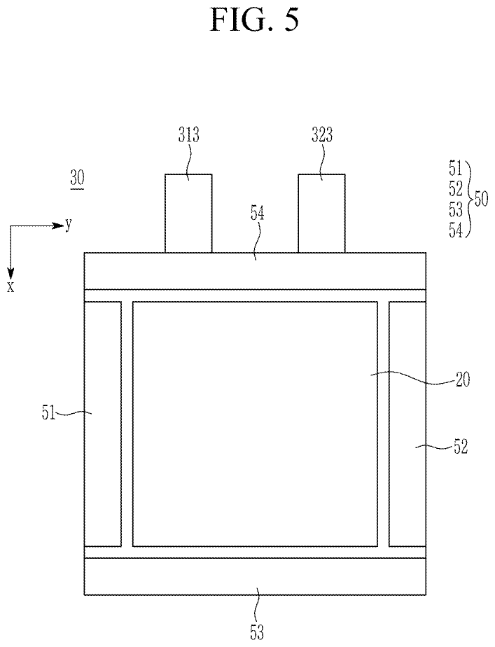

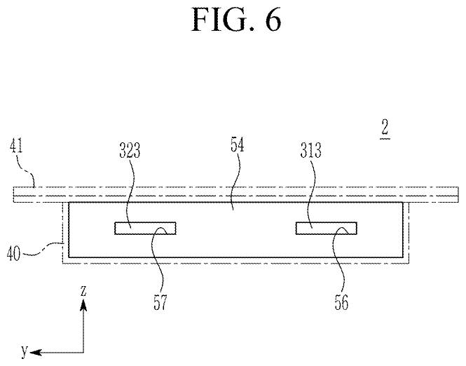

FIG. 5 illustrates a top plan view of an electrode assembly of a rechargeable battery according to another embodiment, and FIG. 6 illustrates a side view viewed from positive and negative tab sides of FIG. 5.

Referring to FIG. 5 and FIG. 6, in a rechargeable battery 2 of the second embodiment, a first film member 50 includes a pair of second-direction films 53 and 54 stretched and attached on both sides of the first direction (x-axis direction) of the electrode assembly 30 in the second direction (y-axis direction), and first-direction films 51 and 52 stretched and attached in the first direction (x-axis direction) between the pair of second-direction films 53 and 54.

Among the pair of second-direction films 53 and 54, the second direction films 54 on the positive electrode tab 313 and negative electrode tab 323 sides may be provided with a pair of through-holes 56 and 57 for drawing out the positive electrode tab 313 and the negative electrode tab 323, respectively. The through-holes 56 and 57 allow the second-direction film 54 to be attached even when the positive electrode tab 313 and the negative electrode tab 323 are drawn out. Therefore, the second-direction film 54 stably controls and prevents the falling flow in one side of the first direction (x-axis direction).

The second-direction films 53 and 54 may be entirely attached to both outer surfaces and side surfaces of the electrode assembly 30 in the second direction (y-axis direction). The second-direction films 53 and 54 may control and prevent the falling flow in one side in the first direction (x-axis direction) more effectively than the second-direction film 13 and the film 14 between the tabs of the first embodiment.

Referring back to FIG. 5, the first film member 50 (51, 52, 53, 54) may have a first area A21, and the second film member 20 may have a second area A22. The first area A21 may be 90 to 110% of the second area A22 [A21=(0.9−1.1)*A22].

When the first area A21 is less than 90% of the second area A22, due to the lack of the first area A21 of the first film member 50, the plane and the side surface of the electrode assembly 30 may not be sufficiently fixed, such that the falling flow may not be sufficiently controlled. When the first area A21 exceeds 110% of the second area A2, due to the excess of the first area A21 of the first film member 50, it may be difficult to attach the plane and the side surface of the electrode assembly 30.

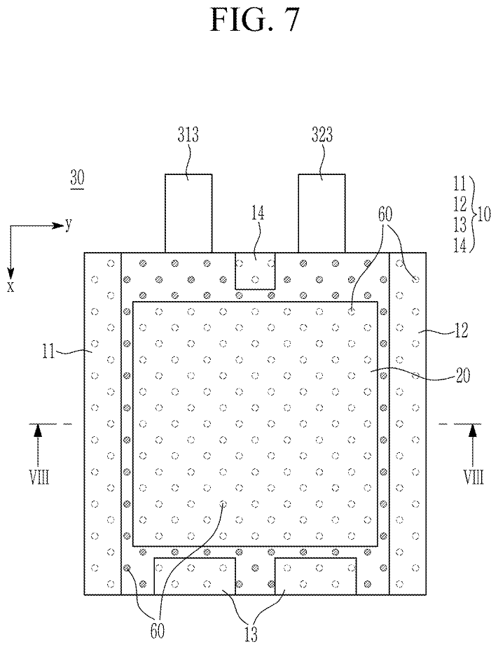

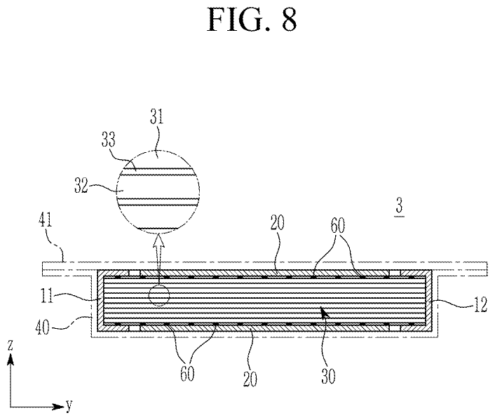

FIG. 7 illustrates a top plan view of an electrode assembly of a rechargeable battery according to a third embodiment of the present disclosure, and FIG. 8 illustrates a cross-sectional view taken along line VIII-VIII of FIG. 7.

Referring to FIG. 7 and FIG. 8, a rechargeable battery 3 of the third embodiment may further include a binder layer 60 applied to both sides of the electrode assembly 30. The first film member 10 and the second film member 20 may be attached on the binder layer 60.

In the first embodiment, the first film member 10 and the second film member 20 may be attached to both outer surfaces and the side surfaces of the outer periphery of the electrode assembly 30. However, in the third embodiment, the first film member 10 and the second film member 20 may be attached to the side surfaces of the outer periphery and both outer surfaces of the electrode assembly 30 as well as the binder layer 60.

The first film member 10 and the second film member 20 may prevent compressed unevenness and a decrease in adhesive force between the separator 33 and the positive and negative electrode plates 31 and 32 that could occur between both outer surfaces of the electrode assembly 30 and the pouch 40 and the cover 41 due to the binder layer 60 during pressurization formation.

As an example, when the binder layer 60 is formed to have a thickness of 5 μm, a problem could occur due to a lack of adhesion with the pouch during pressurization formation. Thus, a distribution of falling flow characteristics and a distribution of long lifespan characteristics may occur.

However, since the first film member 10 and the second film member 20 are further provided on the binder layer 60, adhesion with the pouch 40 and the cover 41 may be secured even during pressurization formation, thereby balancing the falling flow characteristics and long lifespan characteristics.

While this disclosure has been described in connection with what is presently considered to be practical embodiments, it is to be understood that the disclosure is not limited to the disclosed embodiments, but, on the contrary, is intended to cover various modifications and equivalent arrangements included within the scope of the appended claims.

By way of summation and review, embodiments may provide a rechargeable battery that improves flatness between a pouch and an oriented polystyrene (OPS) film while controlling a pull-back phenomenon of a separator by applying the OPS film. The present disclosure further provide a rechargeable battery that may prevent a problem caused by falling flow by increasing a contact area between a pouch and an OPS film

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

<Description of Symbols>

| | |
|---|---|
| 1, 2, 3: rechargeable battery | 10: first film member |
| 11, 12: first-direction film | 13: second-direction film |
| 14: film between tabs | 20: second film member |
| 30: electrode assembly | |
| 31: first electrode plate | |
| (positive electrode plate) | |
| 32: second electrode plate | |
| (negative electrode plate) | |
| 33: separator | |
| 40: pouch | 41: cover |
| 50: first film member | 51, 52: first-direction film |
| 53, 54: second-direction film | 60: binder layer |
| 311: electrode current | |
| collecting plate | |
| 312: positive electrode active | |
| material layer | |
| 313: electrode tab (positive | |
| electrode tab) | |
| 321: electrode current | |
| collecting plate | |
| 322: negative active material | |
| layer | |
| 323: electrode tab (negative | |
| electrode tab) | |
| 401: polymer sheet | 402: nylon sheet |
| 403: aluminum sheet | A1, A21: first area |
| A2, A22: second area | t1: first thickness |
| t2: second thickness | |

What is claimed is:

1. A rechargeable battery comprising:
a stacked type electrode assembly in which a negative electrode plate and a positive electrode plate with electrode tabs are stacked on both sides of a separator;
a pouch that accommodates the electrode assembly;
a first film member that generates adhesive force through an electrolyte solution and is attached to the electrode assembly in a bent and connected state to both outer surfaces and side surfaces of an outer periphery of the electrode assembly; and
a second film member that is spaced apart from the first film member and attached to at least one of the both outer surfaces.

2. The rechargeable battery as claimed in claim 1, wherein
the first film member and the second film member are made of an oriented polystyrene (OPS) film.

3. The rechargeable battery as claimed in claim 1, wherein:
the negative electrode plate and the positive electrode plate have a plane area extending in first and second directions crossing each other and are stacked in a third direction crossing the plane area;
the electrode tabs are drawn out of the pouch along the first direction; and
the first film member is provided on both sides of the plane area in the first direction and both sides of the plane area in the second direction, respectively.

4. The rechargeable battery as claimed in claim 3, wherein:
the first film member includes
a pair of first-direction films that are stretched and attached on both sides of the second direction in the first direction, and
a second-direction film that is stretched and attached in the second direction between the pair of first direction films on a side opposite to a drawing direction of the electrode tab.

5. The rechargeable battery as claimed in claim 4, wherein
the second-direction film is divided and attached along the second direction between the pair of first-direction films.

6. The rechargeable battery as claimed in claim 5, wherein
the second-direction film further includes a film between tabs attached between the electrode tabs.

7. The rechargeable battery as claimed in claim 4, wherein
the second film member is attached to at least one of the both outer surfaces, between the pair of first-direction films and on one side of the second-direction film.

8. The rechargeable battery as claimed in claim 7, wherein
the first film member and the second film member closely adhere to an inner surface of the pouch.

9. The rechargeable battery as claimed in claim 1, wherein:
the first film member has a first thickness, and
the second film member has a second thickness that is twice the first thickness and is attached to one of the both outer surfaces of the electrode assembly.

10. The rechargeable battery as claimed in claim 9, wherein
the first thickness is 24 μm to 34 μm, and the second thickness is 51 μm to 61 μm.

11. The rechargeable battery as claimed in claim 1, wherein:
the first film member has a first thickness, and
the second film member has the first thickness and is attached to both outer surfaces of the electrode assembly.

12. The rechargeable battery as claimed in claim 9, wherein:
the first film member has a first area A1,
the second film member has a second area A2, and
the first area A1 is 60 to 80% of the second area A2 [A1=(0.6−0.8)*A2].

13. The rechargeable battery as claimed in claim 3, wherein:
the first film member includes
a pair of second-direction films that are stretched and attached on both sides of the plane area in the second direction, and
a first-direction film that is stretched and attached on a side of the plane area in the first direction between the pair of second direction films.

14. The rechargeable battery as claimed in claim 13, wherein among the pair of second-direction films, the second direction film on the electrode tab side is provided with a pair of through-holes through which the electrode tabs are respectively drawn out.

15. The rechargeable battery as claimed in claim 14, wherein the pair of second-direction films are attached to the both outer surfaces and the side surfaces entirely in the second direction.

16. The rechargeable battery as claimed in claim 13, wherein:
the first film member has a first area A21,
the second film member has a second area A22, and
the first area A21 is 90 to 110% of the second area A22 [A21=(0.9−1.1)*A22].

17. The rechargeable battery as claimed in claim 1, further including a binder layer applied to the both outer surfaces of the electrode assembly,
wherein the first film member and the second film member are attached on the binder layer.
